(19) United States
(12) Patent Application Publication
(10) Pub. No.: US 2011/0157892 A1
(43) Pub. Date: Jun. 30, 2011

(54) ILLUMINATION DEVICE

(75) Inventors: Jen-Shyan Chen, Hsinchu City (TW); Chun-Jen Lin, Taipei (TW); Wei-Yeh Wen, Jhubei City (TW)

(73) Assignee: NEOBULB TECHNOLOGIES, INC., Bandar Seri Begawan (BS)

(21) Appl. No.: 12/980,631

(22) Filed: Dec. 29, 2010

(30) Foreign Application Priority Data
Dec. 30, 2009 (TW) 098145758

(51) Int. Cl. F21V 7/00

(52) U.S. Cl. 362/247

(57) ABSTRACT

The invention discloses an illumination device. A form factor of the illumination device comprises a shell and a plurality of LED platforms. The shell comprises a plurality of optical reflection components for reflecting light, each of the optical reflection components comprises a bottom surface. Each of the LED platforms, fixed on the bottom surface of one of the optical reflection components, comprises an energy converter, a heat-pipe and a heat-dissipating component. The energy converter, penetrating the bottom surface, comprises a plurality of first LEDs or second LEDs. The heat-pipe comprises a flat portion, an extension portion and a contact portion, wherein the flat portion contacts the energy converter, the extension portion has a bend and extends along a first direction, and the contact portion connects the bend and extends along a second direction. The heat-dissipating component has a plurality of fins, each of the fins contacts the contact portion.

### BACKGROUND OF THE INVENTION

1. Field of the Invention

The present invention relates to an illumination device, and more particularly, to an illumination device having a fixed form factor and a bent heat pipe, wherein the illumination device can further comprise LEDs with various amounts and various luminous efficiencies.

2. Description of the Prior Art

With the development of semi-conductor light emitting devices, a light-emitting diode (LED), which has several advantages such as power save, seismic resistance, quick reaction, and so on, becomes a new light source. In order to raise the intensity of light, high-power LED has been used as the light source in many illumination products. Although high-power LED can provide stronger light, it may also cause other problems related to heat dissipation. For example, if the heat generated by the LED cannot be dissipated in time, the LED will suffer from “heat shock” which may affect the luminous efficiency and reduce the work life of the LED.

Additionally, heat-dissipating component of high-power LED usually has larger size that may also enlarge the size of illumination device. In order to miniaturize the illumination device, the heat-dissipating component has to be improved.

The heat-dissipating component of traditional LED illumination device usually dissipates the heat with a plurality of fins, wherein the fins have to be attached to a carrier which carries the LED to achieve higher heat-dissipating efficiency. However, the size of the fins used for high-power LED is usually large, and the utility of space of the illumination device applied high-power LED will be limited if the fins are required to be attached to the carrier directly.

Therefore, it is necessary to provide an illumination device which could make full use of space inside the device by disposing the fins properly, that is, the illumination device can dissipate heat by the fins which are not limited to contact the carrier directly for solving the above-mentioned problem.

### SUMMARY OF THE INVENTION

A scope of the invention is to provide an illumination device which can not only make full use of space inside the device, but also dissipate the heat generated by LEDs efficiently. Further, the illumination device has a fixed form factor with a plurality of LEDs, and the LEDs comprise several types of luminous efficiency for providing different scales of illumination.

According to an embodiment of the invention, a form factor of the illumination device of the invention comprises a shell and a plurality of LED platforms. The shell comprises a plurality of optical reflection parts for reflecting light, each of the optical reflection parts comprises a bottom surface. Each of the LED platforms, fixed on the bottom surface of one of the optical reflection parts, comprises an energy converter, a heat-pipe, and a heat-dissipating part. The energy converter, penetrating the bottom surface, comprises a plurality of first LEDs or a plurality of second LEDs for generating light. The heat-pipe comprises a flat portion, an extension part, and a contact portion, wherein the flat portion contacts the energy converter, the extension part has a bend and extends along a first direction, the contact portion connects the bend and extends along a second direction. The heat-dissipating part has a plurality of fins, each of the fins contacts the contact portion.

As mentioned above, the n first LEDs generates X±10% lumens while driven by a drive current, the n second LEDs generates Y±10% lumens while driven by the drive current, the m first LEDs generates Y±10% lumens while driven by the drive current, the m second LEDs generates Z±10% lumens while driven by the drive current.

In another embodiment of the invention, each of the LED platforms further comprises a container for containing a control circuit to control the energy converter. Moreover, the container further comprises a connector, electrically connected to the control circuit, for providing the power required by the energy converter and the control circuit

Furthermore, the form factor further comprises a connector, fixed on the shell and electrically connected to the control circuits respectively, for providing the power required by the energy converters and the control circuits.

Additionally, the first direction is approximately perpendicular to the second direction, wherein the fins are approximately perpendicular to the second direction. Moreover, the fins are stacked to form a rectangular cube, wherein each of the fins comprises a hole, and the contact portion, penetrating the holes, is fixed in the holes by a fixing element. Further, the fixing element hitches the contact portion.

To sum up, the illumination device of the invention has a fixed form factor with a plurality of LEDs, and the LEDs comprise several types of luminous efficiency for providing different scales of illumination. Further, the illumination device can make full use of space inside the device by disposing the fins properly, that is, the illumination device can dissipate the heat by transmitting the heat to the fins with a bent heat-pipe. Specially, the bent heat-pipe makes the fins are able to be disposed properly, and the fins can dissipate the heat efficiently.

The advantage and spirit of the invention may be understood by the following recitations together with the appended drawings.

### BRIEF DESCRIPTION OF THE APPENDED DRAWINGS

FIG. 1A illustrates a top view of an illumination device according to an embodiment of the invention.

FIG. 1B illustrates a perspective view of the illumination device according to an embodiment of the invention.

FIG. 2 illustrates a side view of the LED platform according to an embodiment of the invention.

FIG. 3A illustrates a top view of the energy converter and the carrier according to an embodiment of the invention.

FIG. 3B illustrates a sectional view of the energy converter, the carrier, and a part of the heat pipe along Z-Z line in FIG. 3A.

FIG. 4 illustrates a cross section of the energy converter, the carrier, and a part of the heat pipe according to an embodiment.

FIG. 5 illustrates a cross section of the energy converter, the carrier, and a part of the heat pipe according to another embodiment.

FIG. 6 illustrates a cross section of the energy converter, the carrier, and a part of the heat pipe according to another embodiment.

FIG. 7 illustrates a cross section of the energy converter, the carrier, and a part of the heat pipe according to another embodiment.

FIG. 8 illustrates a top view of an illumination device according to another embodiment of the invention.

FIG. 9 illustrates a perspective view of the illumination device according to another embodiment of the invention.

### DETAILED DESCRIPTION OF THE INVENTION

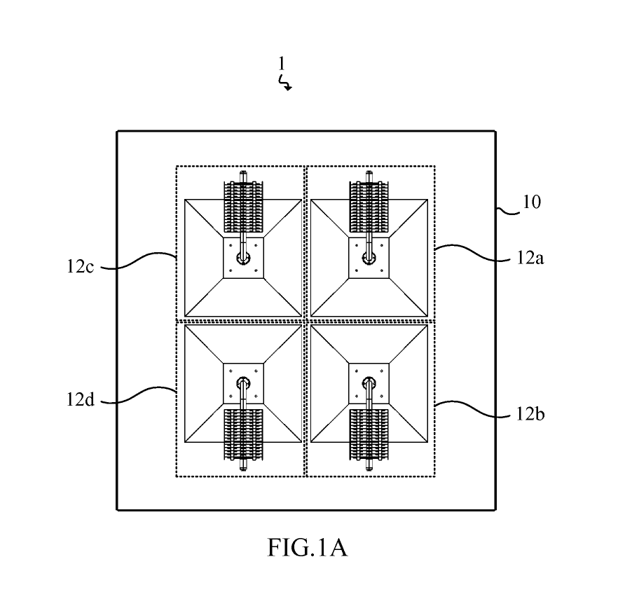

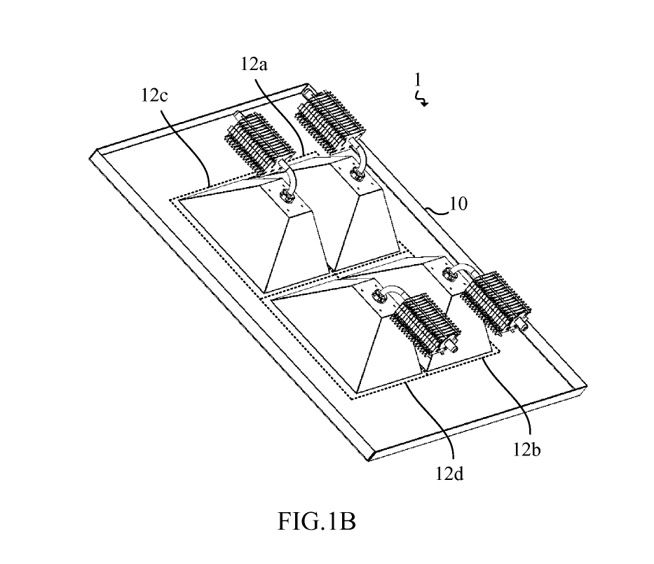

Please refer to FIG. 1A and FIG. 1B. FIG. 1A illustrates a top view of an illumination device according to an embodiment of the invention. FIG. 1B illustrates a perspective view of the illumination device according to an embodiment of the invention. As shown in figures, the illumination device 1 comprises a form factor, and the form factor comprises a shell 10 and a plurality of LED platforms, such as LED platform 12a, LED platform 12b, LED platform 12c, and LED platform 12d, wherein each LED platform is fixed on the shell 10.

Each LED platform, such as the LED platform 12a, comprises a plurality of first LEDs or a plurality of second LEDs. The n first LEDs generates X±10% lumens while driven by a drive current; the n second LEDs generates Y±10% lumens while driven by the drive current; the m first LEDs generates Y±10% lumens while driven by the drive current; the m second LEDs generates Z±10% lumens while driven by the drive current; wherein m>n, Z>Y, Y>X, the second LED having a better luminous efficiency than the first LED.

Therefore, the LED platform 12a can comprise a certain amount of LEDs driven by the drive current. The LED platform 12a can generate more illumination when the LED platform 12 comprises more LEDs driven by the drive current. Further, the LED platform 12a can also comprise LEDs with higher luminous efficiency. In other words, the LED platform 12a can have a fixed form factor and provide different scales of illumination by changing the amount or the luminous efficiency of the LEDs.

Corresponding to different situations, the factor X, Y, Z, m, and n can change accordingly, for example, m=6, n=4, X=350, Y=500, Z=700; m=6, n=4, X=500, Y=700, Z=1000; m=6, n=4, X=700, Y=1000, Z=1400; m=8, n=6, X=700, Y=1000, Z=1400; m=8, n=6, X=1000, Y=1400, Z=2000; wherein the drive current is approximately 530 mA. In practice, the driven current shall tally with specifications of LEDs, the factors are not limited to those examples mentioned above. Obviously, the LED platform 12a is not necessary to be redesigned for providing different scales of illumination, that is, the LED platform 12a can be improved under the fixed form factor.

The details of the LED platform comprised in the form factor of the illumination device 1 are shown thereinafter. It should be mentioned that although the following embodiment takes one of the LED platforms, all of the LED platforms can be applied to the following embodiment.

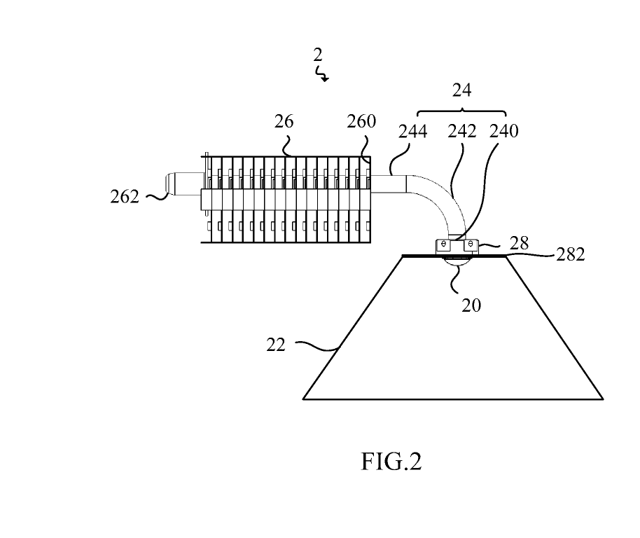

Please refer to FIG. 1A and FIG. 2. FIG. 2 illustrates a side view of the LED platform according to an embodiment of the invention. As shown in figures, the LED platform 2 shown in FIG. 2 can be LED platform 12a, LED platform 12b, LED platform 12c, or LED platform 12d in FIG. 1. The LED platform 2 comprises an energy converter 20, an optical reflection part 22, a heat-pipe 24, a heat-dissipating part 26, and a carrier 28. The optical reflection part 22 can be fixed on the shell 10. In order to show the related positions of the energy converter 20, the heat-pipe 24, and the carrier 28, the optical reflection part 22 is shown perspectively.

The optical reflection part 22 comprises a bottom surface, and the bottom surface of the optical reflection part 22 is fixed to the carrier 28 by a retainer 282. The optical reflection part 22 reflects the light generated by the energy converter 20. In practice, because the light generated by the energy converter 20 radiates in all directions, the optical reflection part 22 can be set around the energy converter 20 to guide the light toward the same direction for increasing the luminous efficiency. For example, the optical reflection part 22 can be, but not limited to, metal, glass, or light-reflecting materials which is set around the energy converter 20.

The heat-pipe 24 comprises a flat portion 240, an extension part 242, and a contact portion 244. The flat portion 240 contacts the energy converter 20, and the extension part 242, having a bend, extending toward a first direction outside the energy converter 20. The contact portion 244 connects the bend and extends toward a second direction. In practice, the heat-pipe is a hollow structure, wherein the hollow structure can have a cylinder outward surface, and the hollow structure can be filled with high thermal conductivity materials.

On the other hand, the heat-dissipating part 26 has a plurality of fins 260, wherein each of the fins 260 contacts the contact portion 244. Because the bend which connects the extension part 242 and the contact portion 244 can adjust the extending direction of the extension part 242, the location of the heat-dissipating part 26 can be changed accordingly. Therefore, the heat-dissipating part 26 can be disposed on any proper location within the illumination device 1, and the heat can be transmitted to the heat-dissipating part 26 through the heat-pipe 24. Furthermore, this invention can be applied to a thin illumination device.

In practice, the fins 260 can be approximately parallel or perpendicular to the second direction, and the fins 260 can be stacked to form a rectangular cube. Moreover, each of the fins 260 can have a hole, wherein the contact portion 244 penetrates those holes to contact those fins 260. The contact portion 244 can further be fixed in the holes by a fixing element, wherein the fixing element hitches the contact portion 244.

The energy converter 20, penetrating the bottom surface, is able to send out the light, and the energy converter 20 can comprise a plurality of LEDs with different luminous efficiencies. In practice, the energy converter 20 is generally used to provide a plurality of LEDs, and the way for the energy converter 20 to carry the LEDs shall not be limited. For example, the energy converter 20 can comprise a substrate and a base, the LEDs can be disposed on the substrate, and the substrate connects the base for exposing the LEDs. Wherein the LEDs can be either formed on the substrate; or the LEDs can be chips die bonded on the base; or the base comprises a first sunken portion and a second sunken portion connected to the first sunken portion, the substrate contacts with the flat portion 240 and connects the second sunken portion, the LEDs are exposed outside the first sunken portion.

As shown in FIG. 2, the energy converter 20, disposed on the carrier 28, is fixed on the carrier 28 to let the energy converter 20 contact with the flat portion 240 of the heat-pipe 24. The carrier 28 is fixed on the optical reflection part 22 by a retainer 282. In practice, an optical modulator, connected to the carrier 28, can adjust the light generated from the energy converter 20. For example, the optical modulator can be a lens structure aligned with the energy converter 20. Besides, the carrier 28 may comprise a thread structure, disposed on the side of the carrier 28, for screwing the optical modulator onto the carrier 28. Further, the optical modulator can also be inset to the carrier 28 by a hook structure.

There are several embodiments are shown thereinafter that further illustrate the structures between the energy converter 20 and the carrier 28.

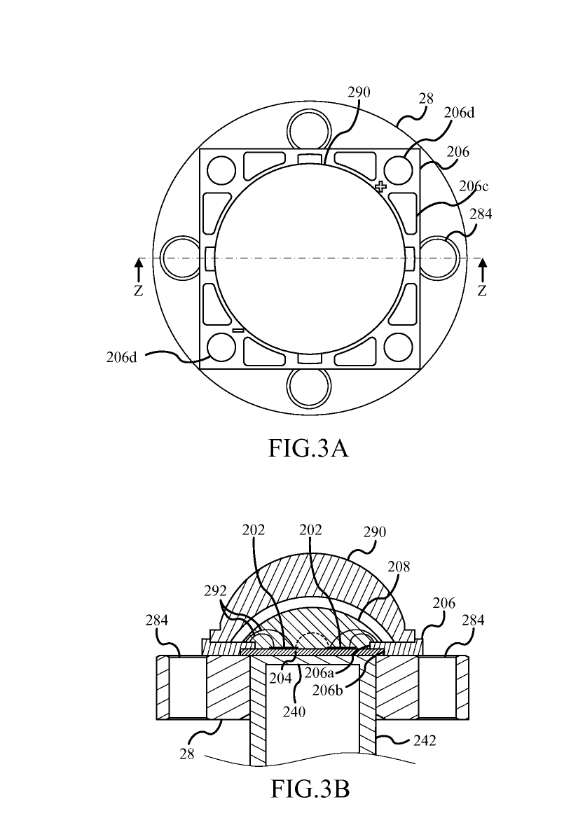

Please refer to FIG. 3A and FIG. 3B. FIG. 3A illustrates a plane view of the energy converter 20 and the carrier 28 of the LED platform 2. FIG. 3B illustrates a cross section of the energy converter 20, the carrier 28, and a part of the heat-pipe 24 along line Z-Z in FIG. 3A. According to the first preferred embodiment, the energy converter 20 includes an energy transducing semiconductor structures 202, a substrate 204 and a base 206. The energy transducing semiconductor structures 202, known as the first LEDs and the second LEDs earlier, are disposed on the substrate 204. The base 206 includes a first sunken portion 206a and a second sunken portion 206b connected to the first sunken portion 206a. The substrate 204 contacts with the flat portion 240 and is connected to the second sunken portion 206b, and the energy transducing semiconductor structure 202 are exposed out of the first sunken portion 206a. The carrier 28 has a through hole 282 for containing wires, wherein the wires can provide the power to the energy converter 20.

The energy transducing semiconductor structure 202 is an independent sunken portion chip and it is fixed (die bonded) on the substrate 204. The energy transducing semiconductor structure 202 is wired to inner electrodes of the base 206 with metal wires 292 and then the energy transducing semiconductor structure 202 is electrically connected to the control circuit through wires welded to outer electrodes 206c which is connected to the inner electrodes on the base 206 (please also refer to FIG. 2). The energy transducing semiconductor structure 202 and metal wires 292 are fixed or sealed on the substrate 204 by a packing material 208. The base 206 is fixed on the carrier 28 by screwing screws through holes 206d to the carrier 28. The packing material 208 is also able to adjust light. If the contour of the packing material 208 is protrusive as shown in FIG. 3B, the packing material 208 is able to converge light.

According to the first preferred embodiment, the energy converter 20 includes a lens 290 disposed on the base 206. The lens 290 is able to converge light, but not limited to it. With a proper design on the curvatures of two sides of the lens 290, the lens 290 is able to converge or scatter light for satisfying different optical adjustment requirements. In practical application, the optical adjustment effect of the LED platform 2 also need to consider optical characters of a lens structure of the optical modulator. What is remarkable is that the lens structure of the optical modulator is not limited to a convex lens. For example, there can further comprise a recess at the middle of the lens structure and thus light is converged to become a ring shape roughly by the lens structure.

Please refer to FIG. 3A and FIG. 3B. Additionally, the base 206 could be formed by imbedding a lead frame of metal into a mold and then injecting liquid crystal plastic into the mold. Therein, the inner electrodes defined on the lead frame are exposed out of the first sunken portion 206a, and the outer electrodes 206c are exposed out of the base 206. Additionally, the energy transducing semiconductors 202 could be connected in serial by wiring as shown by the dotted line in FIG. 3B. Meantime, the energy transducing semiconductor structure 202 in FIG. 3B only retains one metal wire 292 to be connected to the base 206. If there is a circuit on the substrate 204, for example a semiconductor substrate with a circuit formed in process or a circuit board coated with a metal circuit, the energy transducing semiconductor structure 202 could be wired to the substrate 204 and then electrically connected to the base 206 through the substrate 204. If the substrate 204 is designed not to be a medium for electrical connection, the substrate 204 could be made of a metal material or other materials with high thermal conductivity for raising the thermal conduction efficiency of conducting the heat generated by the energy transducing semiconductor structure 202 to the flat portion 240.

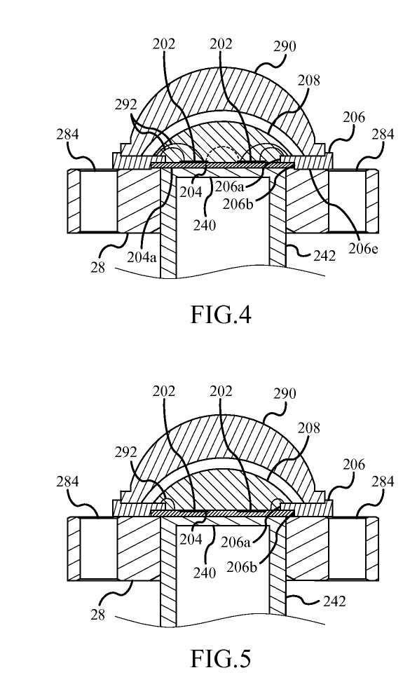

Please refer to FIG. 4. FIG. 4 illustrates a cross section of the energy converter 20, the carrier 28, and a part of heat-pipe 24 according to an embodiment. The difference between the FIG. 4, FIG. 3A, and FIG. 3B is that the substrate 204 in FIG. 4 is disposed in the second sunken potion 206b entirely. Therefore, the bottom surface 206e of the base 206 slightly protrudes out of the bottom surface 204a (for contacting with the flat portion 240) of the substrate 204. Correspondingly, the flat portion 240 protrudes out of the carrier 28 and the protrusive height of the flat portion 240 is slightly greater than the concave depth of the bottom surface 204a of the substrate 204 for ensuring that the substrate 204 is stuck on the flat portion 240 tightly.

Similarly, the flat portion 240 could slightly protrude out of the carrier 28 and the bottom surface 206e of the base 206 and the bottom surface 204a of the substrate 204 are coplanar. The above purpose for ensuring sticking tightly could also be achieved. In the structure shown in FIG. 3B, if there is a gap between the base 206 and the flat portion 240, a thermal conductive glue could be coated on the bottom surface of the base 206 or the flat portion 240 to be filled with the gap. Of course, in the structure as shown in FIG. 4, the thermal conductive glue could be coated on the bottom surface 206e of the base 206 or the flat portion 240 to be filled with the gap formed due to surface roughness of the bottom surface 206e or the flat portion 240.

Please refer to FIG. 3B and FIG. 5. FIG. 5 illustrates a cross section of the energy converter 20, the carrier 28, and a part of the heat-pipe 24 according to another embodiment. The difference between FIG. 3B and FIG. 5 is that the energy transducing semiconductor 202 in FIG. 5 is formed on the substrate 204 directly; for example, the substrate 204 is a semiconductor substrate (a silicon substrate). Therefore, the energy transducing semiconductor 202 could be integrated to form on the substrate 204 easily in a semiconductor process. Additionally, the electrodes of the energy transducing semiconductor structure 202 formed on the semi-substrate 204 could be integrated on the substrate 204 in advance, so that only two times of wiring are required to the energy transducing semiconductor structure 202. The stability of the fabrication could increase thereby.

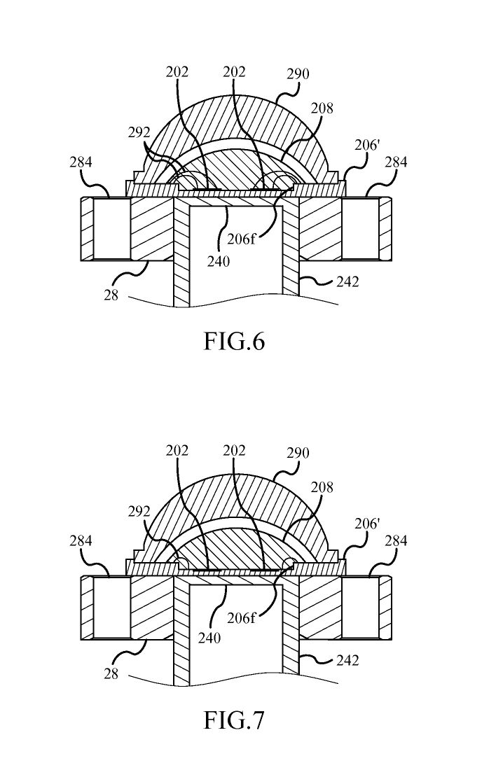

Please refer to FIG. 3B and FIG. 6. FIG. 6 illustrates a cross section of the energy converter 20, the carrier 28, and a part of the heat-pipe 24 according to another embodiment. The difference between FIG. 6 and FIG. 3B is that the energy transducing semiconductor structure 202 in FIG. 6 is disposed directly on a base 206′ having a recess 206f rather than on the substrate 204 as shown in FIG. 3B. Additionally, in practical application, the base 206′ could be a plate where the energy transducing semiconductor 202 is disposed directly. The description about the energy converter 20 in FIG. 3B is also applied here, and it will no longer be explained.

Please refer to FIG. 6 and FIG. 7. FIG. 7 illustrates a cross section of the energy converter 20, the carrier 28 and a part of the heat-pipe 24 according to another embodiment. The difference between FIG. 3B and FIG. 7 is that the energy transducing semiconductor structure 202 in FIG. 7 is formed directly on a base 206′. Of course, in practical application, the base 206′ could be a plate. The description about the energy converter 20 in FIG. 5 is also applied here, and it will no longer be explained.

In general, illumination device can be controlled by the control circuit, and the control circuit can be contained within a container. Besides, the control circuit is used to control the energy converter for adjusting the luminous efficiency of the LEDs or for controlling other functions.

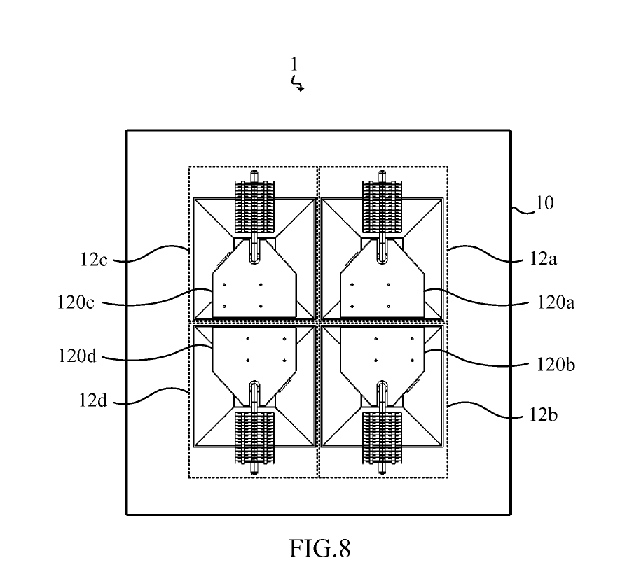

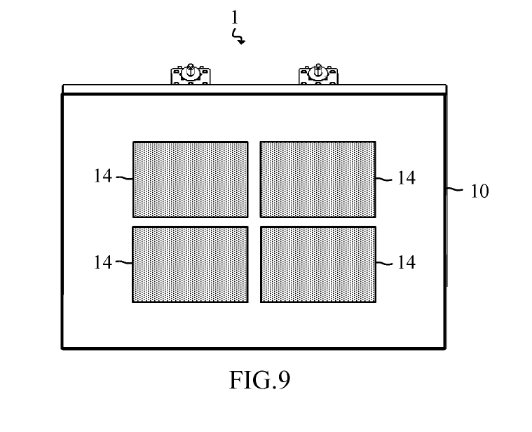

Please refer to FIG. 8, FIG. 8 illustrates a top view of an illumination device according to another embodiment of the invention. As shown in FIG. 8, the illumination device 1 has an form factor, wherein the comprises a shell 10 and a plurality of LED platforms such as a LED platform 12a, a LED platform 12b, a LED platform 12c, and a LED platform 12d. Moreover, each LED platform comprises a container 120a, a container 120b, a container 120c, and a container 120d, respectively, wherein each container is fixed on the corresponding LED platform.

The container can be used to contain a control circuit (not shown in FIG. 8) for controlling the energy converter. Additionally, each container can further comprise a connector (not shown in FIG. 8), electrically connected to the control circuit, to provide the power that the energy converter required. It should be mentioned that the connector does not have to be disposed inside the container, the connector can further be fixed on the shell 10 and electrically connected to the control circuit of each LED platform. The connector can be disposed on any proper location of the illumination device 1 to provide the power that the energy converter required without interfering with other components.

In addition, the control circuit can comprise a circuit board or other electric components. The control circuit coupled to the energy converter by the wire electric connected to the connector. The carrier of each LED platform can also have a through hole to let the wire penetrate through it. Besides, the control circuit can be coupled to the connector by other wire. Further, the connector is coupled to a power source to obtain the power for the control circuit to control the energy converter. For example, the connector is coupled to a power source to obtain the power which is required by the LEDs.

Moreover, according to another embodiment of the invention, the illumination device can further comprise a plurality of optical homogenizer (diffuser) for homogenizing the light generated by the energy converter. Please refer to FIG. 9, FIG. 9 illustrates a perspective view of the illumination device according to another embodiment of the invention. As shown in FIG. 9, a plurality of optical homogenizer 14 can be fixed on the shell 10 of the illumination device 1, and each of the optical homogenizer 14 is correspondingly fixed on one of the optical reflection parts. In practice, the optical homogenizer 14 is used to homogenize the light, and each optical reflection part can be designed to tally with the optical homogenizer 14 or other components which can provide different visual effects. Although the flat optical homogenizer 14 is shown above, those skilled in the art should know that the use of a big-size optical homogenizer which can cover all of the optical homogenizers 14 is a common way to realize the invention. The optical homogenizer 14 is not limited to a flat contour, that the optical homogenizer 14 can have a curved contour or other shapes.

To sum up, the illumination device of the invention has a fixed form factor with a plurality of LEDs, and the LEDs comprise several types of luminous efficiency for providing different scales of illumination. Further, the illumination device can make full use of space inside the device by disposing the fins properly, that is, the illumination device can dissipate the heat by transmitting the heat to the fins with a bent heat-pipe. Specially, the bent heat-pipe makes the fins are able to be disposed properly, and the fins can dissipate the heat efficiently. On the other hand, the illumination device can dissipate the heat by transmitting the heat to the heat-dissipating part with a bent heat-pipe, that is, the heat-dissipating of the illumination device can be greatly enhanced. In other words, the heat generated by the LEDs can be dissipated in time, the LEDs will not suffer from the “heat shock” for increasing the work life.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An illumination device, having a form factor, the form factor comprising:
a shell comprising a plurality of optical reflection components for reflecting light, each of the optical reflection components comprising a bottom surface; and
a plurality of LED platforms, each of the LED platforms, fixed on the bottom surface of one of the optical reflection components, comprising:
an energy converter, penetrating the bottom surface, comprising a plurality of first LEDs or a plurality of second LEDs to emit light;
a heat-pipe comprising a flat portion, an extension portion, and a contact portion, wherein the flat portion contacting the energy converter, the extension portion has a bend and extends along a first direction toward the form factor of the energy converter, and the contact portion connects the bend and extends along a second direction; and
a heat-dissipating component having a plurality of fins, each of the fins contacting the contact portion;
wherein if the form factor and a drive current is approximately constant, when one of the LED platforms comprises n first LEDs generating X±10% lumens while driven by the drive current and one of the LED platforms comprises m first LEDs generating Y±10% lumens while driven by the drive current, one of the LED platforms comprises n second LEDs generates Y±10% lumens while driven by the drive current and one of the LED platforms comprises m second LEDs generates Z±10% lumens while driven by the drive current;
wherein m>n, Z>Y, Y>X, and the luminous efficiency of the second LED is higher than that of the first LED.

2. The illumination device of claim 1, wherein the converter further comprises a substrate and a base, the first LEDs or the second LEDs are disposed on the substrate, and the substrate is connected to the base for exposing the first LEDs or the second LEDs.

3. The illumination device of claim 2, wherein the first LEDs or the second LEDs are formed on the substrate.

4. The illumination device of claim 2, wherein the first LEDs or the second LEDs are chips die bonded on the base.

5. The illumination device of claim 2, wherein the base comprises a first sunken portion and a second sunken portion connected to the first sunken portion, the substrate is contacted with the flat portion and connected to the second sunken portion, the first LEDs or the second LEDs are exposed outside the first sunken portion.

6. The illumination device of claim 1, wherein the energy converter comprises a base, and the first LEDs or the second LEDs are disposed on the base.

7. The illumination device of claim 6, wherein the base comprises a recess, and the first LEDs or the second LEDs are disposed on the recess.

8. The illumination device of claim 6, wherein the first LEDs or the second LEDs are formed on the base.

9. The illumination device of claim 6, wherein the first LEDs or the second LEDs are chips die bonded on the base.

10. The illumination device of claim 1, wherein the form factor further comprises a carrier, connected to the heat-pipe, and the energy converter is fixed on the carrier to contact with the flat portion.

11. The illumination device of claim 10, wherein the carrier is fixed on the optical reflection component by a retainer.

12. The illumination device of claim 10, wherein each of the LED platforms further comprises an optical modulator, connected to the carrier, for adjusting the light generated from the energy converter, wherein the carrier comprises a thread structure, disposed on the side of the carrier, for screwing the optical modulator onto the carrier.

13. The illumination device of claim 1, wherein the first direction is approximately perpendicular to the second direction, and each of the fins comprises a hole, and the contact portion, penetrating the holes, is fixed in the holes by a fixing element.

14. The illumination device of claim 13, wherein the fixing element hitches the contact portion.

15. The illumination device of claim 1, wherein the shell further comprises a plurality of optical homogenizers, each of the optical homogenizer is fixed on one of the optical reflection components.
